(19) United States
(12) Patent Application Publication
(10) Pub. No.: US 2007/0266033 A1
(43) Pub. Date: Nov. 15, 2007

(54) System and method for profiling members of dating servers

(75) Inventor: Warren H. Kelly, Woodbridge, VA (US)

Correspondence Address: VENABLE LLP, P.O. BOX 34385, WASHINGTON, DC, 20043-9998, US

(73) Assignee: MATCHinform, Incorporated, Woodbridge, VA (US)

(21) Appl. No.: 11/633,081

(22) Filed: Dec. 4, 2006

Related U.S. Application Data
(60) Provisional application No. 60/741,884, filed on Dec. 5, 2005.

(51) Int. Cl. G06F 17/30

(52) U.S. Cl. 707/10

(57) ABSTRACT

A system and method for profiling users of a service generally comprises a database including a plurality of records, each of which describes an experience of the users within the service, means for rating each of the plurality of records which relates to the experience, and means for remotely accessing the database. In such a manner, users can pick service provides bases upon the quality of service provided by such service providers.

### BACKGROUND OF THE INVENTION

The present invention is directed generally to online services, and more particularly to systems and methods for profiling members of online dating services.

According to the U.S. population survey “How America Searches” (by icrossing and Harris Interactive), 88% of online adults who purchase online conduct research at least sometimes prior to completing their purchase. Only 3% of online adults who purchase items online never do any type of online research before making online purchases, and only 9% of respondents say they rarely research products and services online. Sixty-five percent said they often/always rely on the Internet to research unfamiliar products, while 60% always or often research to find the best price.

An overwhelming 42% of participants, who indicated that they use at least one online tool or service to research products, cited search engines first, well ahead of the 17% who turn to retailer/seller web sites first. When search engines are the first tool to which people turn to find more information, 54% of respondents use search engines to find a web site from which to buy or 53% search to investigate where to purchase. Forty-three percent indicated they use search engines to find an offline retailer from which to buy.

Eighty-two percent of men ages 18-34 and 80% of men age 55 years and older, of the 74% who use search engines to research products/services look to learn more about their intended products. Sixty percent of adults who use search engines to research products/services before buying online said they click on sponsored links at least sometimes, and 16% indicated they do so always/often. Just 9% indicated they never click on sponsored links when looking for a specific product or service.

The report also showed that older shoppers are more likely to click on sponsored links. Forty-eight percent of adults aged 18-34 click on sponsored links at least sometimes, 61% among those aged 35-44, 64% in the 45-54 age group, and 75% among adults over the age of 55. Finally, the report also noted that, although blogs have had a dramatic effect on arenas such as current events and politics they remain a negligible source of information for adults conducting product research before making a purchase.

What this data shows is that online consumers overwhelmingly like to find out more about the products they are about to buy. What it does not show, however, is that users of services (e.g., online dating services) are similarly predisposed.

In previous years, online dating services saw massive double-digit percentage gains in business. That, however, is expected to change this year. The online dating industry grew by 73% in 2002 and 77% in 2003. In 2004, however, those high numbers began to drop—the 2004 online dating market grew by only 19%. According to an online dating research report from Dublin Research and Markets, the online dating industry will grow by just 9%, to $516 million, in 2005.

Because of the decline in industry growth, dating sites have focused on increasing conversions of viewers into paying subscribers in order to keep growing. The report states that conversion rates in the online dating industry have increased about 25% in the last year. Many dating sites are also paying more attention to serious daters rather than casual daters to increase their site revenue.

Serious daters, the report shows, are those people who go online hoping to find long-term relationships or marriage. Serious daters convert 20% more often, are twice as likely to purchase long-term subscriptions and pay up to twice as much per month as casual daters.

While online dating leaders Match.com and Yahoo! Personals are struggling to grow revenues, relationship-focused eHarmony has drawn increased attention from consumers, the media, and venture capitalists. It is this relationship focus that many dating sites are turning toward in order to increase their financial success.

A recent study by Dr. Jeff Gavin, of the University of Bath, has also revealed several interesting facts about the online dating industry. The most intriguing discovery of the study is that online dating has become a much more successful way to find long-term romance and friendship than was previously thought. The study of online dating service members found that 94 percent of those surveyed saw their “e-partner” again after first meeting them, and the relationships lasted for an average of at least seven months, with 18 percent of them lasting over a year.

Other findings of the study include:
men online were significantly more likely to be committed to the relationship than women and were more dependent on their “e-partner”;
the more the couple engaged in simultaneous online chat before meeting rather than simply e-mailing one another, the more they were found to depend on one another emotionally and the more they understood one another;
those who exchanged gifts before meeting had a more committed and deeper relationship;
the more the couple talked on the telephone before they met, the deeper the relationship; and
people using the Internet rarely used webcams, which allow computer users to see one another, because they preferred the greater anonymity of writing and using the telephone.

For the study, Dr Gavin, with Dr Adrian Scott of the University of Bath and Dr Jill Duffield of the University of the West of England, carried out an online survey of 229 people, aged 18 to 65, who have used UK Internet dating sites, asking them about their main relationship that they had had online. Of the relationships, 39 percent were still going on at the time of the survey, and of these 24 percent had been going for at least a year, and eight percent for at least two years. Of the relationships that had already ended at the time of the survey, 14 percent had lasted over a year, and four percent had lasted over two years.

What this data shows is that online dating services have been successful in the past, but are somewhat struggling now. They are using interesting if not unusual marketing ploys to remain competitive. However, they are not necessarily using systems or methods of profiling their subscriber base to assist them in growing their business.

For example, two top online dating services firms have recently been taken to court by frustrated online daters who say they were victims of fraud. Match.com, a unit of IAC/Interactive Corp., has been accused in a federal lawsuit of goading members into renewing their subscriptions through bogus romantic e-mails sent out by company employees. In some instances, the suit contends, people on the Match payroll even went on sham dates with subscribers as a marketing ploy. The company has about 15 million members worldwide and 250 employees.

In a separate suit, Yahoo Inc.'s “Yahoo! Personals service has been accused of posting profiles of fictitious potential dating partners on its Web site to make it look as though many more singles subscribe to the service than actually do. The suits, which both seek class-action status, came as growth in the online dating industry has slowed, although Web matchmaking still remains a big business.

The Match lawsuit, in particular, was filed by a plaintiff, who contends he went out with a woman he met through the site who turned out to be nothing more than “date bait” working for the company. The relationship went nowhere, according to his suit. The plaintiff says Match set up the date for him because it wanted to keep him from pulling the plug on his subscription and was hoping he'd tell other potential members about the attractive woman he met through the service.

What these and other anecdotes about the perils of online dating services underscore is the extent to which users of such online services need and want more information.

### SUMMARY OF THE INVENTION

The present invention is dedicated to improving the online relationship experience. Online dating has now grown well beyond the “computer dating” stigma once attached to it. Internet dating is now a mainstream means of meeting and dating.

While meeting over the Internet may have achieved mainstream status, this medium carries with it inherent risks. Almost everyone involved in this form of relationship searching knows that while each service offers a brief description or profile of the person of interest, the information, unfortunately, is only as good as the person who authored the profile. There are virtually no means offered to verify the identity, character, marital status, or any other aspect found in the profile.

Some studies have shown that up to 20% of the membership of these services are married or otherwise seriously involved in relationships, while others have been very generous with regard to describing their height, income, employment status, education level and more.

The objective of the systems and methods disclosed herein is to keep singles from wasting valuable time, when a simple search allows the user to spend that time on more productive dating experiences. The user will create “credit reports”, giving the user the opportunity to pass on accurate information regarding the user's experiences with particular Internet dating members. This information will be available to those using Internet dating services. Through user cooperation, an expanded searchable database gives members of the online dating community the ability to use these reports to make an informed decision before communicating with members of dating services. Singles can limit distribution of their personal contact and other information to those do not meet their dating goals.

### BRIEF DESCRIPTION OF THE DRAWINGS

Preferred embodiments of the invention will now be described in connection with the associated drawings, in which:

FIG. 1 depicts a first graphical user interface for searching and filing a report;

FIG. 2 depicts a second graphical user interface detailing a drop down menu for selecting one of a plurality of dating services;

FIGS. 3A through 3D depict portions of a third graphical user interface for filling a report according to embodiments of the present invention;

FIGS. 4A through 4C depict a flowchart illustrating methods according to embodiments of the present invention;

FIG. 5 depicts a fourth graphical user interface for reviewing one or more particular reports returned on a search conducted with the first graphical user interface according to FIG. 1;

FIG. 6 depicts a fifth graphical user interface for displaying an overview of a particular report linked from the graphical user interface according to FIG. 5;

FIGS. 7A and 7B depict portions of a sixth graphical user interface for detailing the particular report having been overviewed by the graphical user interface according to FIG. 6; and

FIG. 8 depicts a block diagram of a system according to embodiments of the present invention.

### DETAILED DESCRIPTION OF PREFERRED EMBODIMENTS

In the following description and claims, the terms “connected” and “coupled,” along with their derivatives, may be used. It should be understood that these terms are not intended as synonyms for each other. Rather, in particular embodiments, “connected” may be used to indicate that two or more elements are in direct physical or electrical contact with each other. In contrast, “coupled” may mean that two or more elements are in direct physical or electrical contact with each other or that the two or more elements are not in direct contact but still cooperate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical (e.g., electronic) quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

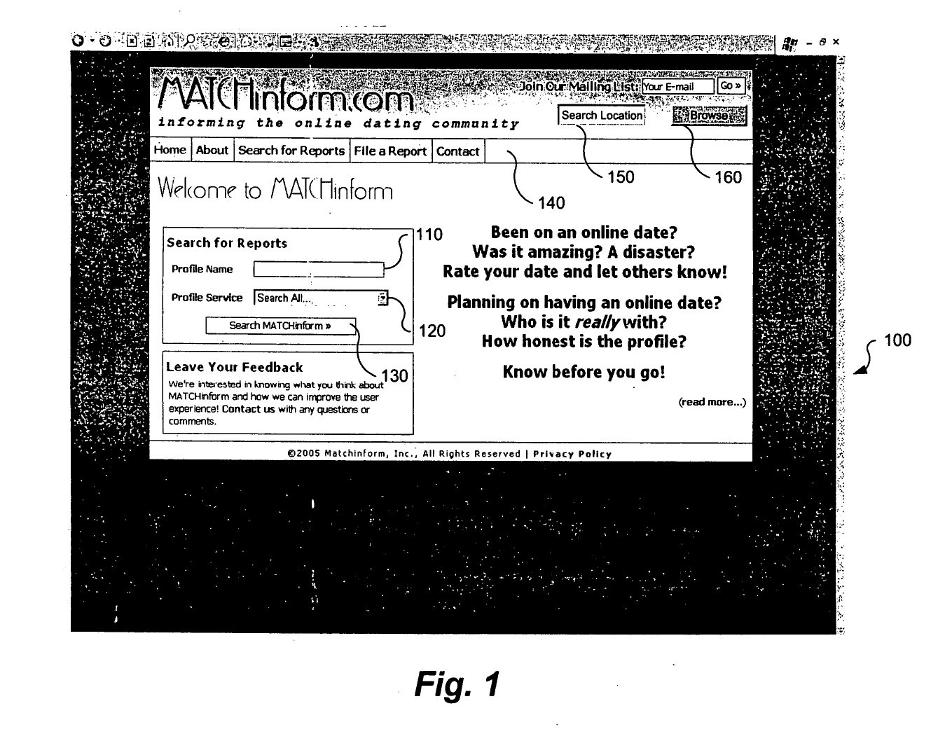

FIG. 1 depicts a first graphical user interface (GUI) 100 for searching and filing a report in accordance with aspects of the present invention. GUI 100 includes an edit box 110 for entering the profile name of a member of an online dating service, a drop down menu 120 for selecting all or one of a plurality of online dating services to be searched, and a button 130 for initiating the search. GUI 100 also includes a menu 140 for navigating the website, which provides the systems and methods according to various aspects of the present invention, including means to “File a Report”. For the purposes of making broader searches based on location, or to browse reports, GUI 100 further includes another edit box 150 and a browse button 160.

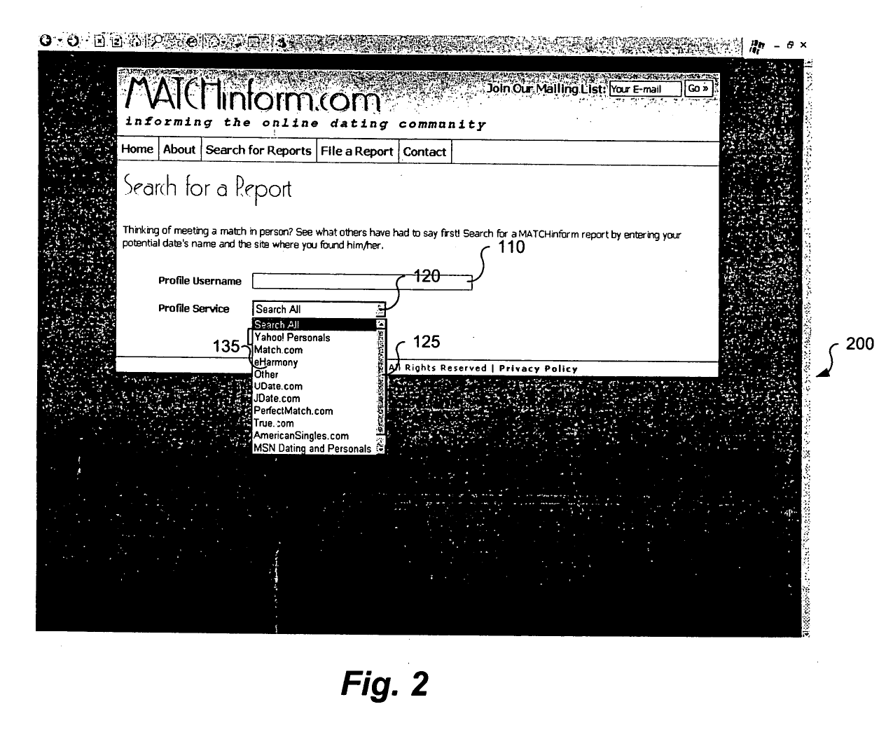

FIG. 2 depicts a second graphical user interface (GUI) 200 detailing the drop down menu 120 for selecting one or more of a plurality of dating services 135. One or more of such services 135 can be viewed for selection by using a scroll bar 125 or similar such means. While any online dating service may be incorporated within the systems and methods according to the present invention, the plurality of dating services 130 may include eHarmony, American Singles, LavaLife, Udate, Match.com, DreamDates, Romantic Planet, FriendFinder, MatchMaker, AgeMatch.com, KissyKat, PerfectMatch.com, Dating Direct, Date.com, ePersonals.com, MetroDate, Yahoo!Personals, Platinum Romance, Europe Singles, True, Singles4You, SingleMe, Love.com, Mingles, or GreatBoyfriends.

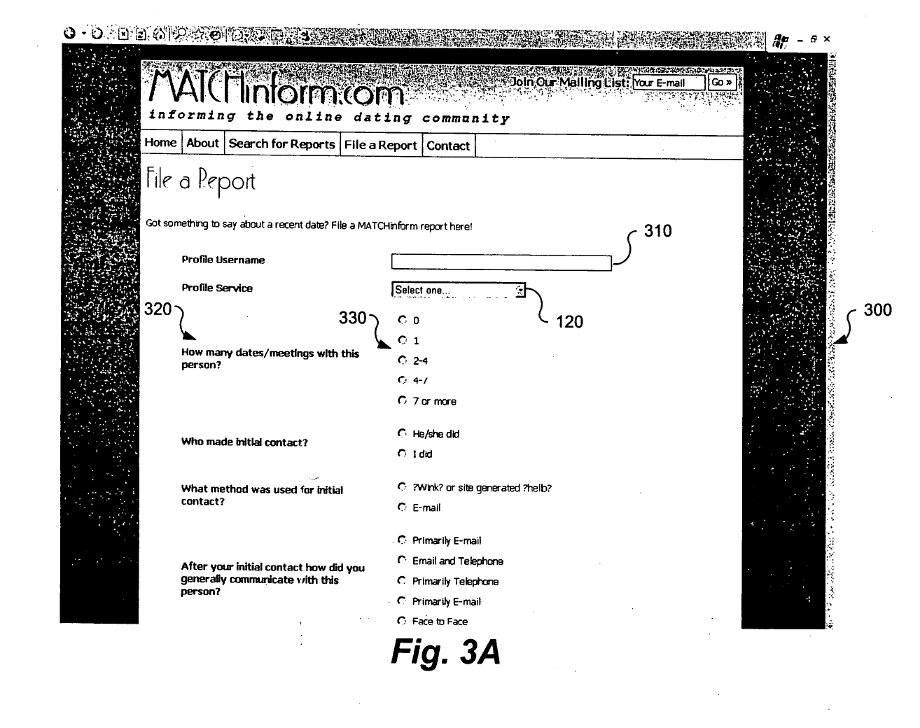

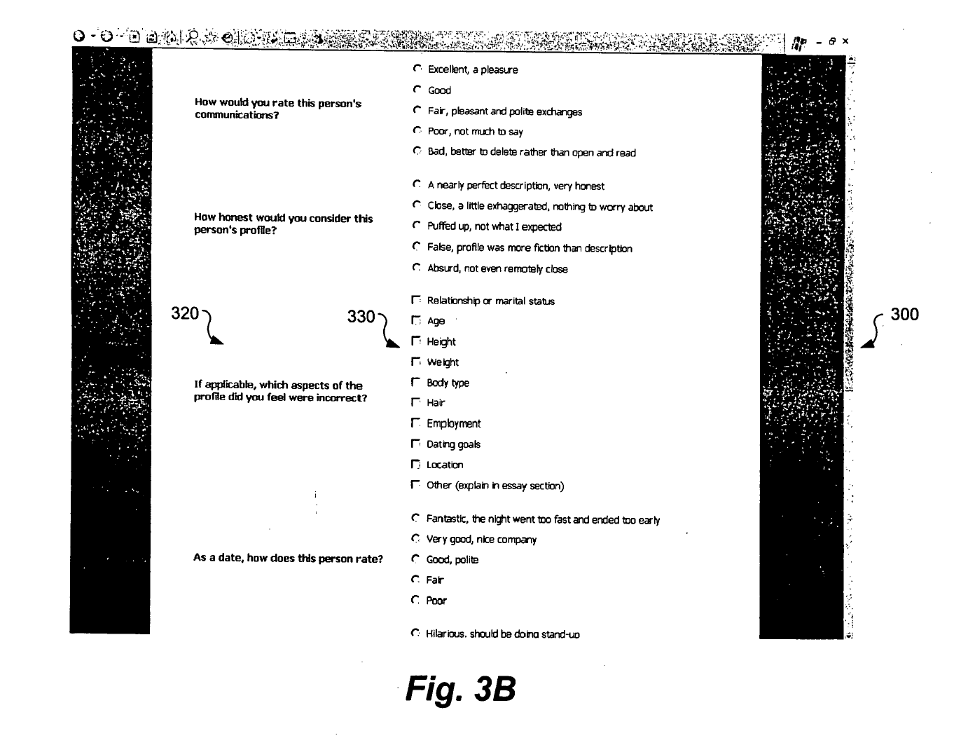

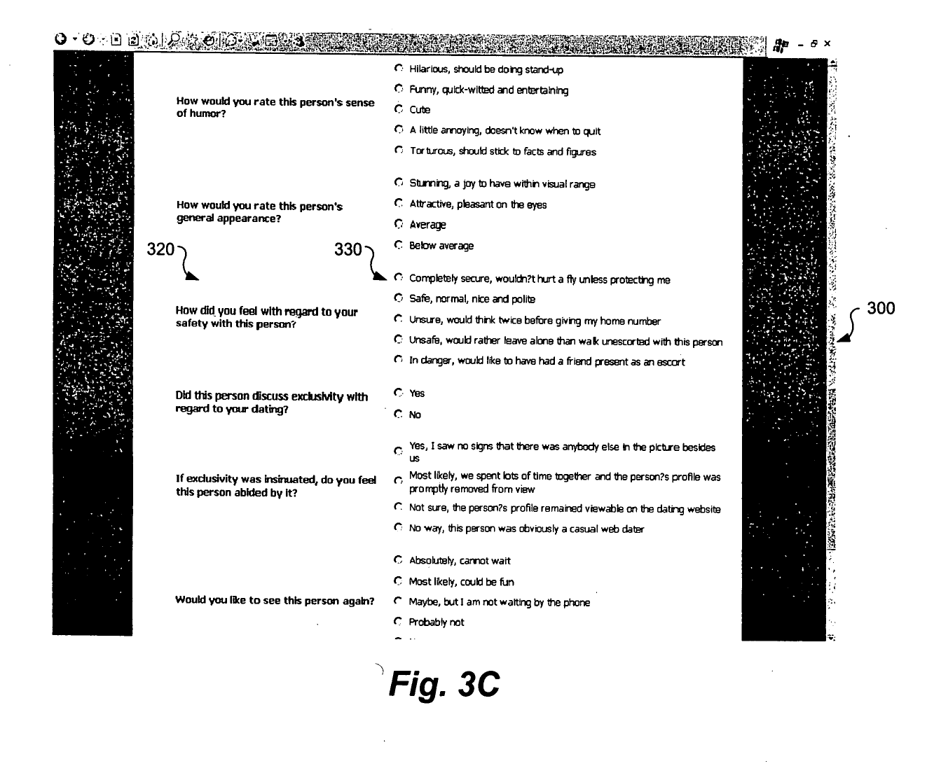

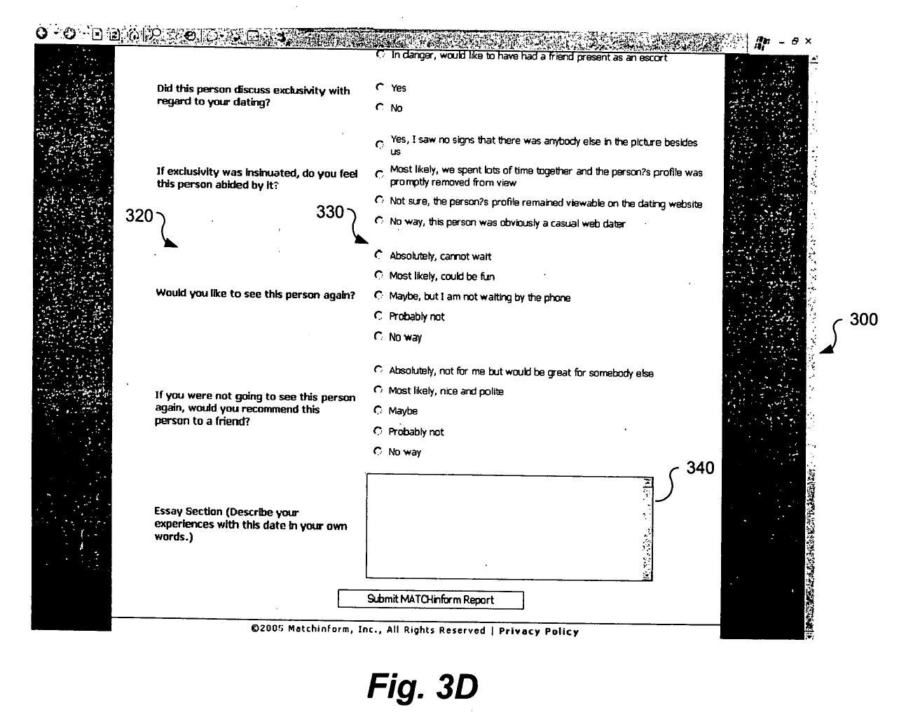

FIGS. 3A through 3D depict portions of a third graphical user interface (GUI) 300 for filing a report according to embodiments of the present invention. GUI 300 includes an edit box 310 for entering the username of a user intended to be profiled and drop down menu 120 for selecting the online dating service to which that username may be associated by way of membership. Some usernames may be used with more than one online dating service. As a result, and in the event that the profiler knows such information, drop down menu 120 may be adapted to select more than one of the plurality of dating services 135.

GUI 300 also includes a plurality of questions 320 to be asked of the profiler and a corresponding number of radio buttons 330, which indicate the response to such questions 320. As shown in FIG. 3D, GUI 300 may also include an edit box 340 to be used as an essay section to describe the profiler's experiences with this particular date in the profiler's own words. In such a manner, a text-based search of submitted reports may be accessed according to embodiments of the present invention.

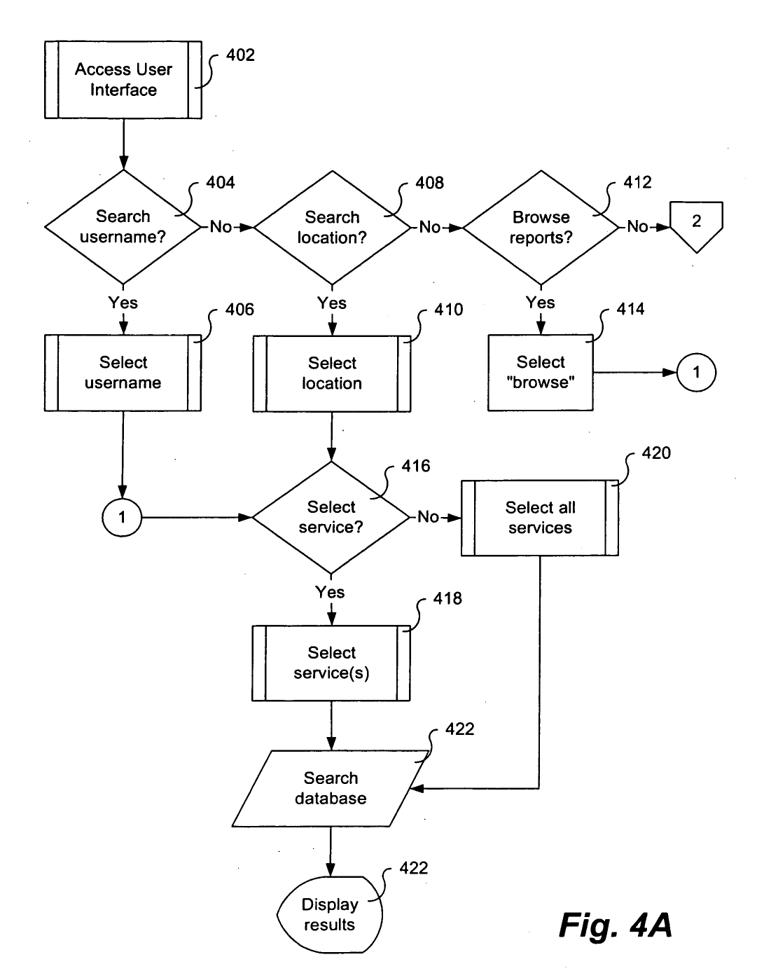

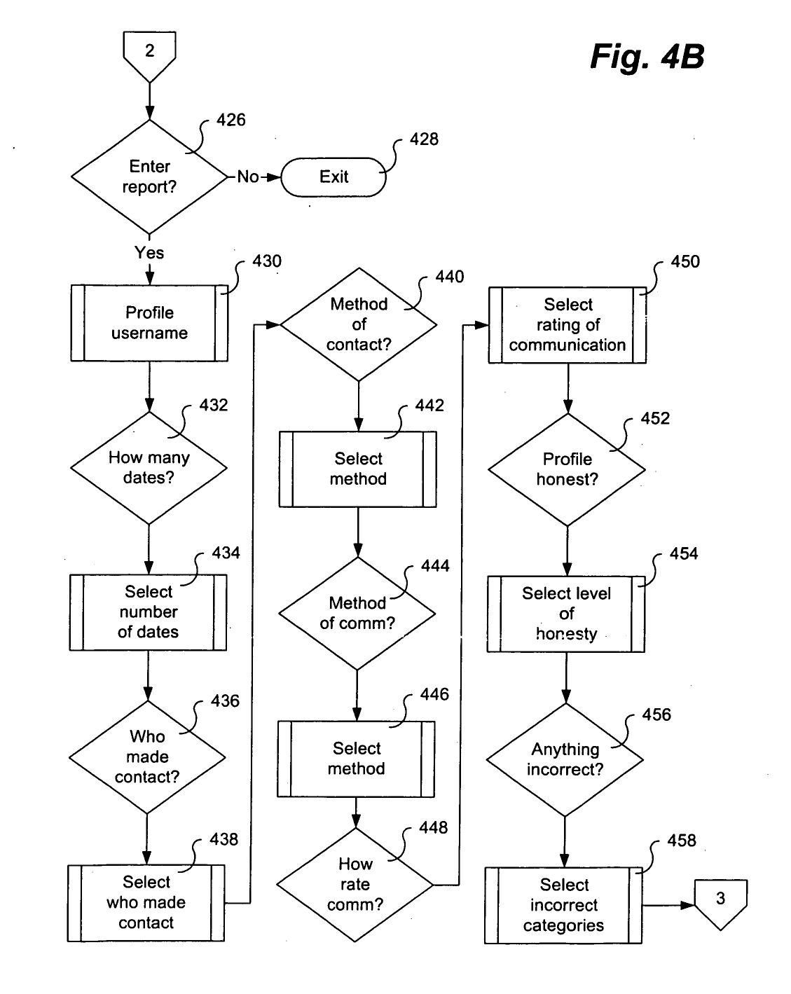

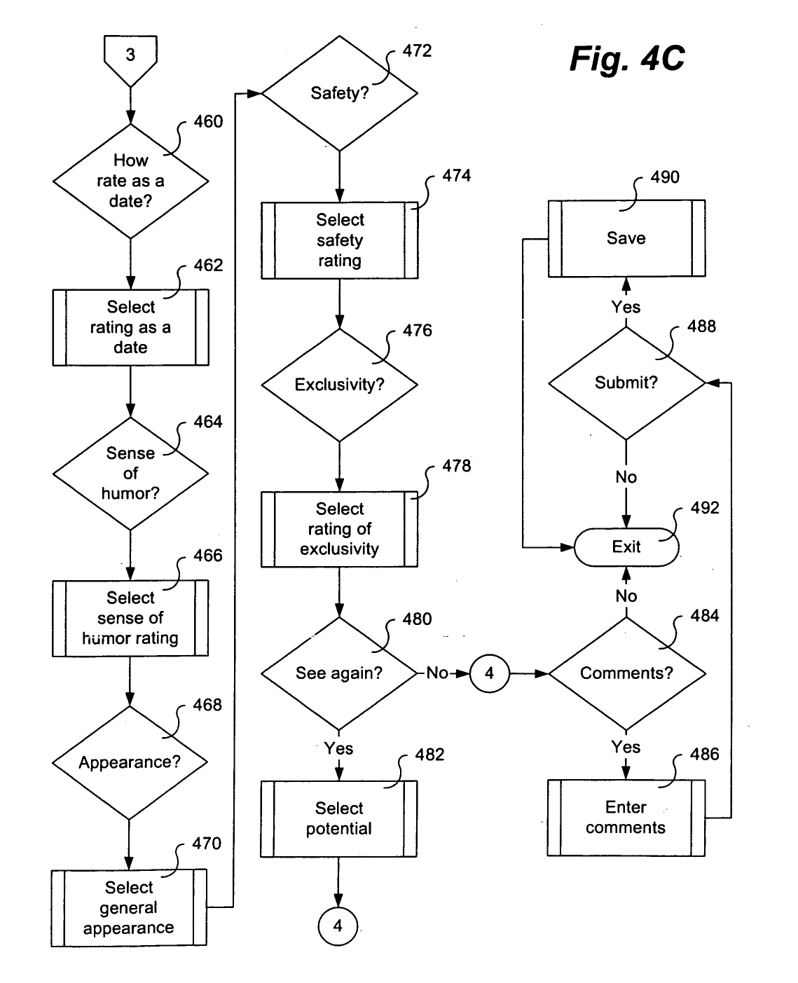

FIGS. 4A through 4C depict a flowchart illustrating methods according to embodiments of the present invention. Users of the system and methods according to the present invention may access the first user interface shown in FIG. 1 at step 402. A determination whether the user might just want to search for a particular username would then be made at step 404. If so, the user would then select that username at step 406 by entering it into the edit box 110 shown in FIG. 1. If not, a determination would then be made whether the user might just want to search for a particular location at step 408. In that event, data (e.g., any given area code, city code, country code, postal code, or ZIP code) could be entered by the user at step 410 into the other edit box 150 shown in FIG. 1. If not, a determination would then be made at step 412 whether the user might just want to browse reports. If so, the user would then select the browse button 160 shown in FIG. 1 at step 414. If not, the user would proceed according to embodiments of the present invention as shown in FIGS. 4B and 4C.

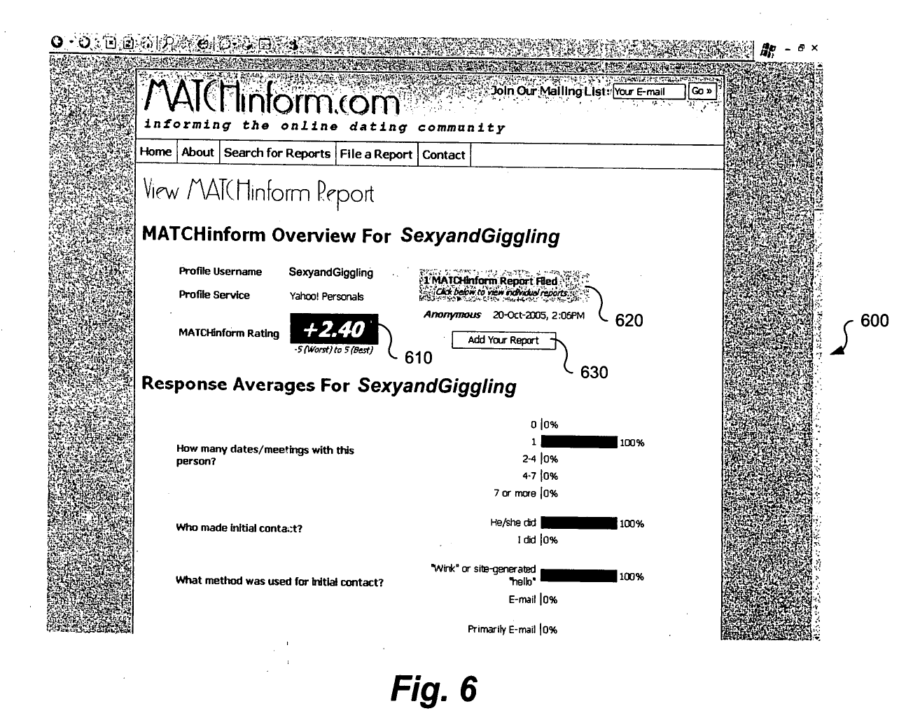

Assuming that the user had either selected a username at step 406, selected a location at step 410, or selected “browse” at step 414, the next step 416 would be a determination whether the user might want to search in one or more of the online dating services 135. If so, the user would then select at step 418 particular ones of the plurality of online dating services 135. If not, the default “Search All” would select all services at step 420. In either case, the user would then at step 422 search the database of the system according to embodiments of the present invention. The results of such search would then be displayed at step 424 in the manner shown in FIG. 6.

Referring now to FIG. 4B, there is shown a continuation of a program according to embodiments of the present invention. In the event that the user did not want to search for a particular username, search for a particular location, or browse reports in the database, a determination would then be made at step 426 whether the user might just want to enter a report on a particular username. If not, the user would be prompted to exit the site at step 428.

If so, the user would then select a particular username at step 430 by entering that username in the edit box 310 shown in FIG. 3A. Thereafter, the user would be prompted to answer a plurality of questions 320 by selecting one or more of the plurality of radio buttons 330 shown in FIG. 3A.

For example, the user might first be asked at step 432 how many dates/meetings he or she had had with the person identified by the username entered into edit box 310. A response might then be indicated at step 434 by the user's selecting one of the radio buttons 330 corresponding to 0, 1, 2-4, 4-7, or 7 or more dates/meetings.

Then, the user might be asked who made the initial contact at step 436. In response to that question 320, the user might then indicate the appropriate answer at step 438 by selecting one of the radio buttons 330 corresponding to “he/she did” or “I did”.

Next, the user might be asked what method was used for the initial contact at step 440. In response to that question 320, the user might then indicate the appropriate answer at step 442 by selecting one of the radio buttons 330 corresponding to “?Wink? or site generated ?hello?” or “I did”.

Then, the user might be asked at step 444 how the user generally communicated, after the initial contact, with the person identified by the username entered into the edit box 310. In response to that question 320, the user might then indicate the appropriate answer at step 446 by selecting one of the radio buttons 330 corresponding to “primarily e-mail”, “e-mail and telephone”, etc. as shown in FIG. 3A.

Referring now to FIG. 3B in conjunction with FIG. 4B, the user would then be asked at step 448 how they would rate the person's communications. An appropriate response would then be made at step 450 by the user's selecting one of the radio buttons 330 shown in FIG. 3B.

Then, the user might be asked at step 452 how honest they would consider the person's profile. In response to that question 320, the user might then indicate the appropriate answer at step 454 by selecting one of the radio buttons 330 corresponding to the answers shown in FIG. 3B.

Next, the user might be asked at step 456, if applicable, which aspects of the profile the user felt were incorrect. In response to that question 320, the user might then indicate the appropriate aspects at step 458 by selecting one or more of the radio buttons 330 corresponding to the answers shown in FIG. 3B.

Referring now to FIG. 4C in conjunction with FIG. 3B, the user would then be asked at step 460 how they would rate the person as a date. An appropriate response would then be made at step 462 by the user's selecting one of the radio buttons 330 shown in FIG. 3B.

Then, the user might be asked at step 464 how they would rate the person's sense of humor. In response to that question 320, the user might then indicate the appropriate answer at step 466 by selecting one of the radio buttons 330 corresponding to the answers shown in FIG. 3C.

Next, the user might be asked at step 468 how they would rate the person's general appearance. In response to that question 320, the user might then indicate the appropriate answer at step 470 by selecting one of the radio buttons 330 corresponding to the answers shown in FIG. 3C.

Then, the user might be asked at step 472 how they felt with regard to their own safety with that person. In response to that question 320, the user might then indicate the appropriate answer at step 474 by selecting one of the radio buttons 330 corresponding to the answers shown in FIG. 3C.

Next, the user might be asked at step 476 whether the person discussed exclusivity with regard to their dating. In response to that question 320, the user might then indicate the appropriate answer at step 478 by selecting one of the radio buttons 330 corresponding to the answers shown in FIG. 3C. There also might be one or more follow-on exclusivity related questions as shown in FIG. 3C.

Then, the user might be asked at step 480 whether they would like to see the person again. In response to that question 320, the user might then indicate the appropriate answer at step 482 by selecting one of the radio buttons 330 corresponding to the answers shown in FIG. 3C. In either case, the user might then be asked at step 484 to describe in their own words their experience with the person being profiled. Such comments might be added in the edit box 340 shown in FIG. 3D at step 486. The user would then be prompted at step 488 to submit the report by pressing the “submit” button 350 shown in FIG. 3D. If so, the report would be saved in the database at step 490. If not, the user would exit the site at step 492.

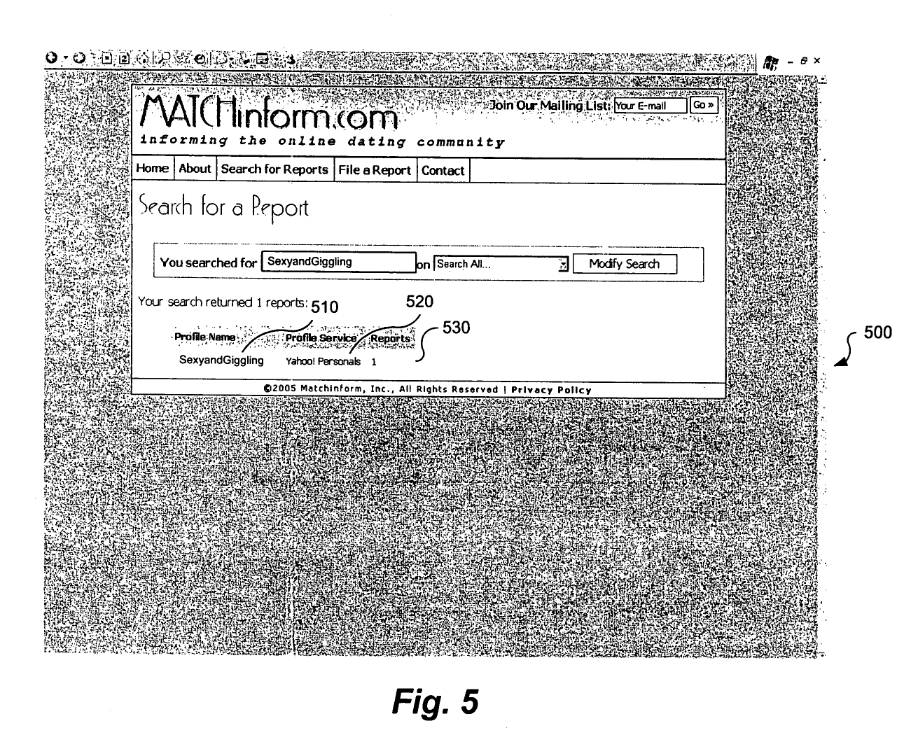

FIG. 5 depicts a fourth graphical user interface (GUI) 500 for reviewing one or more particular reports returned on a search conducted with the first graphical user interface according to FIG. 1.

As shown in FIG. 5, the user might enter “SexyandGiggling” as the username in edit box 110 of FIG. 1. In response, GUI 500 would be displayed showing the profile name 510 (e.g., SexyandGiggling), profile service 520 (e.g., Yahoo!Personals), and the number of reports available to review.

The user might then select the hyperlink to “SexyandGiggling” under the profile name 510. Thereafter, a fifth graphical user interface (GUI) 600 as shown in FIG. 6 would display an overview of a particular report linked from the GUI 500 according to FIG. 5. Such overview may include a rating 610, means 620 for accessing a detailed report, and means 630 for entering an additional report on the particular username in the manner just described. The rating 610 as shown in FIG. 6 runs from a minus five to a plus five, indicating worst to best. Other systems for rating the profiled username might include a zero to ten, also indicating worst to best.

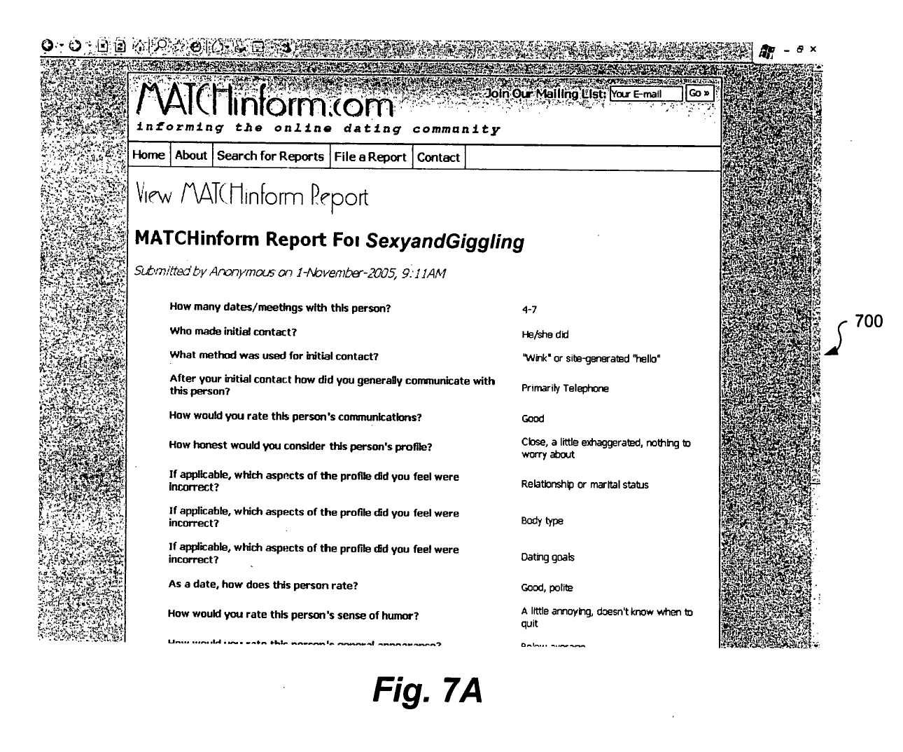

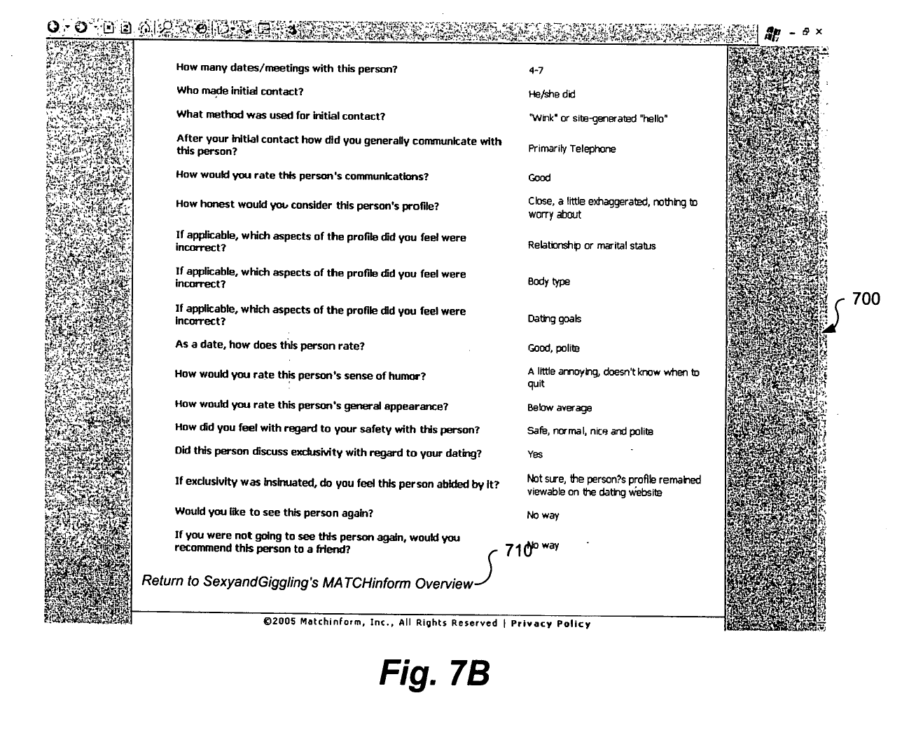

By selecting the means 620 for accessing a detailed report, the user may access a sixth graphical user interface (GUI) 700, as shown in FIGS. 7A and 7B, for detailing the particular report having been overviewed by the GUI 600 according to FIG. 6. Such detailed report not only provides the questions 320 and answers 330 provided by previous users who had profiled the particular username, but also the means 710 to return to that username's overview profile and rating 610.

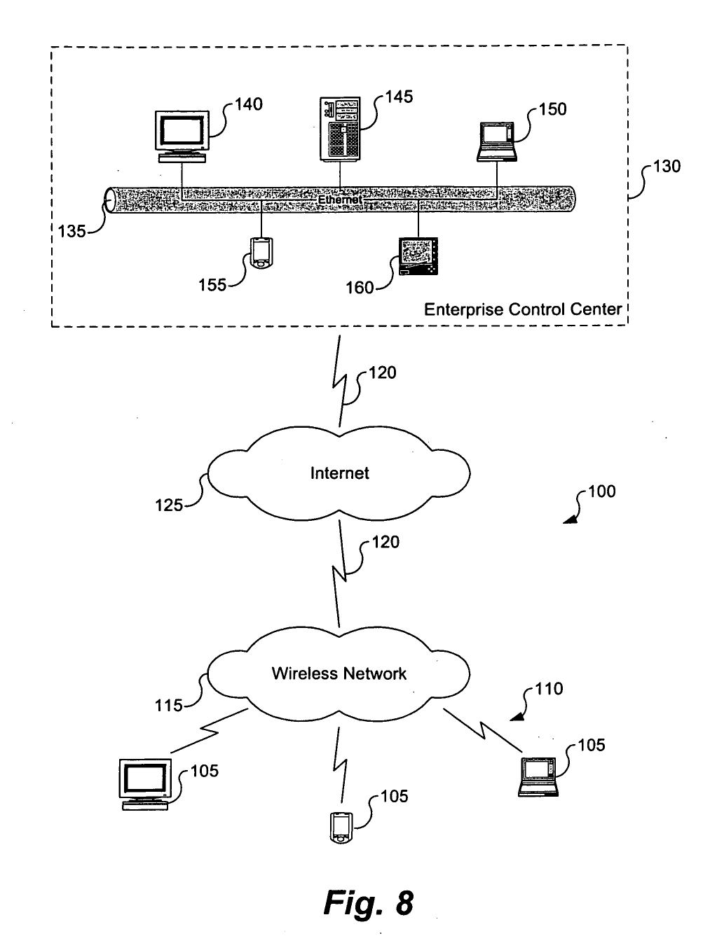

A simple system 800 according to embodiments is shown in FIG. 8. System 800 generally comprises a plurality of clients 105, which may be wirelessly coupled by a first coupling means 110 to a wireless network 115. The wireless network 115, in turn, is coupled by a second coupling means 120 to a large-scale network such as the Internet 125. It should be understood that the foregoing use of the term “Internet” is not intended to limit the present invention to a network also known as the World Wide Web. Embodiments according to the present invention may likewise include intranets, extranets, Virtual Private Networks (VPNs), and the like. Such clients 105, in turn, may suitably comprise one or more conventional personal computers and workstations, operating either as a “fat” client or a “thin” client. However, other clients such as personal digital assistants (PDAs), Web-enabled hand-held devices (e.g., the Palm V™ organizer manufactured by Palm, Inc., Santa Clara, Calif. U.S.A., Windows CE devices, and “smart” phones) which use the wireless access protocol, and Internet appliances.

Such second coupling means 120 may also be used to couple communications from the plurality of clients 105, through the wireless network 115 and Internet 125, to an enterprise control center 130 containing the database and means for accessing the database as described herein before. In turn, the enterprise control center may comprise a local area network of computers coupled together by way of an Ethernet 135. Such computers may comprise a desktop computer or workstation 140, a tower computer or server, 145, a laptop computer 150, a personal digital assistant (PDA) 155, or a pen-based notebook 160.

The database may be structured as a flat file database or as a relational database. A flat file database is a relatively simple database system in which each database is contained in a single table. In contrast, relational database systems can use multiples tables to store information, and each table can have a different record format.

Tables for the database may include:

Table Structure for Table Answers

| Field | Type | Null | Default |
|---|---|---|---|
| answer_id | int(4) | No | |
| Question_id | int(3) | No | 0 |
| answer_weight | int(1) | No | 0 |
| answer_text | varchar(255) | No | |

Dumping Data for Table Answers

| | | | |
|---|---|---|---|
| 1 | 1 | 1 | 0 |
| 2 | 1 | 2 | 1 |
| 3 | 1 | 3 | 2-4 |
| 4 | 1 | 4 | 4-7 |
| 5 | 1 | 5 | 7 or more |
| 6 | 2 | 0 | He/she did |
| 7 | 2 | 2 | I did |
| 8 | 3 | 0 | “Wink” or site generated “hello” |
| 9 | 3 | 1 | E-mail |
| 10 | 4 | 0 | Primarily E-mail |
| 11 | 4 | 1 | Email and Telephone |
| 12 | 4 | 2 | Primarily Telephone |
| 13 | 4 | 3 | Primarily E-mail |
| 14 | 4 | 4 | Face to Face |
| 15 | 5 | 0 | Excellent, a pleasure |
| 16 | 5 | 1 | Good |
| 17 | 5 | 2 | Fair, pleasant and polite exchanges |
| 18 | 5 | 3 | Poor, not much to say |
| 19 | 5 | 4 | Bad, better to delete rather than open and read |
| 20 | 6 | 0 | A nearly perfect description, very honest |
| 21 | 6 | 1 | Close, a little exhaggerated, nothing to worry about |
| 22 | 6 | 2 | Puffed up, not what I expected |
| 23 | 6 | 3 | False, profile was more fiction than description |
| 24 | 6 | 4 | Absurd, not even remotely close |
| 25 | 7 | 0 | Relationship or marital status |
| 26 | 7 | 1 | Age |
| 27 | 7 | 2 | Height |
| 28 | 7 | 3 | Weight |
| 29 | 7 | 4 | Body type |
| 30 | 7 | 5 | Hair |
| 31 | 7 | 6 | Employment |
| 32 | 7 | 7 | Dating goals |
| 33 | 7 | 8 | Location |
| 34 | 7 | 9 | Other (explain in essay section) |
| 35 | 8 | 0 | Fantastic, the night went too fast and ended |
| | | | too early |
| 36 | 8 | 1 | Very good, nice company |
| 37 | 8 | 2 | Good, polite |
| 38 | 8 | 3 | Fair |
| 39 | 8 | 4 | Poor |
| 40 | 9 | 0 | Hilarious, should be doing stand-up |
| 41 | 9 | 1 | Funny, quick-witted and entertaining |
| 42 | 9 | 2 | Cute |
| 43 | 9 | 3 | A little annoying, doesn't know when to quit |
| 44 | 9 | 4 | Torturous, should stick to facts and figures |
| 45 | 10 | 0 | Stunning, a joy to have within visual range |
| 46 | 10 | 1 | Attractive, pleasant on the eyes |
| 47 | 10 | 2 | Average |
| 48 | 10 | 3 | Below average |
| 49 | 11 | 0 | Completely secure, wouldn't hurt a fly unless |
| | | | protecting me |
| 50 | 11 | 1 | Safe, normal, nice and polite |
| 51 | 11 | 2 | Unsure, would think twice before giving my home |
| | | | number |
| 52 | 11 | 3 | Unsafe, would rather leave alone than walk |
| | | | unescorted with this person |
| 53 | 11 | 4 | In danger, would like to have had a friend present as |
| | | | an escort |
| 54 | 12 | 0 | Yes |
| 55 | 12 | 1 | No |
| 56 | 13 | 0 | Yes, I saw no signs that there was anybody else |
| | | | in the picture besides us |
| 57 | 13 | 1 | Most likely, we spent lots of time together and the |
| | | | person's profile was promptly removed from view |
| 58 | 13 | 2 | Not sure, the person's profile remained viewable |
| | | | on the dating website |
| 59 | 13 | 3 | No way, this person was obviously a casual web |
| | | | dater |
| 60 | 14 | 0 | Absolutely, cannot wait |
| 61 | 14 | 1 | Most likely, could be fun |
| 62 | 14 | 2 | Maybe, but I am not waiting by the phone |
| 63 | 14 | 3 | Probably not |
| 64 | 14 | 4 | Noway |
| 65 | 15 | 0 | Absolutely, not for me but would be great |
| | | | for somebody else |
| 66 | 15 | 1 | Most likely, nice and polite |
| 67 | 15 | 2 | Maybe |
| 68 | 15 | 3 | Probably not |
| 69 | 15 | 4 | No way |

| | | | |
|---|---|---|---|
| Field | Type | Null | Default |

Table Structure for Table Blurs

| | | | |
|---|---|---|---|
| blur_answer | int(4) | No | 0 |
| blur_question | int(4) | No | 0 |

Table Structure for Table Questions

| | | | |
|---|---|---|---|
| question_id | int(4) | No | |
| question_weight | int(2) | No | 0 |
| question_type | Enum(‘single’, ‘multiple’) | No | single |
| question_text | varchar(255) | No | |

Dumping Data for Table Questions

| | | | |
|---|---|---|---|
| 1 | 2 | Single | How many dates/meetings with this person? |
| 2 | 4 | Single | Who made initial contact? |
| 3 | 5 | Single | What method was used for initial contact? |
| 4 | 6 | Single | After your initial contact how did you generally |
| | | | communicate with this person? |
| 5 | 8 | Single | How would you rate this person's communications? |
| 6 | 10 | Single | How honest would you consider this person's profile? |
| 7 | 12 | multiple | If applicable, which aspects of the profile did you feel |
| | | | were incorrect? |
| 8 | 14 | Single | As a date, how does this person rate? |
| 9 | 16 | Single | How would you rate this person's sense of humor? |
| 10 | 18 | Single | How would you rate this person's general appearance? |
| 11 | 20 | Single | How did you feel with regard to your safety with this |
| | | | person? |
| 12 | 22 | Single | Did this person discuss exclusivity with regard to your |
| | | | dating? |
| 13 | 24 | Single | If exclusivity was insinuated, do you feel this person |
| | | | abided by it? |
| 14 | 26 | Single | Would you like to see this person again? |
| 15 | 28 | Single | If you were not going to see this person again, |
| | | | would you recommend this person to a friend? |

Table Structure for Table response_answers

| Field | Type | Null | Default |
|---|---|---|---|
| response_id | int(7) | No | 0 |
| question_id | int(3) | No | 0 |
| answer_id | int(4) | No | 0 |

Table Structure for Table Responses

| Field | Type | Null | Default |
|---|---|---|---|
| response_id | int(7) | No | |
| response_stamp | timestamp | Yes | CURRENT_TIMESTAMP |
| subject_id | int(7) | No | 0 |
| subscriber_id | int(6) | No | 0 |
| response_text | text | No | |
| response_approved | enum | No | no |
| | (‘no’, ‘yes’) | | |

Table Structure for Table Services

| | | | |
|---|---|---|---|
| Field | Type | Null | Default |

| | | |
|---|---|---|
| service_id | int(2) | No |
| service_name | Varchar(255) | No |

Dumping Data for Table Services

| | |
|---|---|
| 1 | Yahoo! Personals |
| 2 | Match.com |
| 3 | eHarmony |
| 4 | Other |
| 5 | UDate.com |
| 6 | JDate.com |
| 7 | PerfectMatch.com |
| 8 | True.com |
| 9 | AmericanSingles.com |
| 10 | MSN Dating and Personals |
| 11 | Friendster.com |

Table Structure for Table Subjects

| Field | Type | Null | Default |
|---|---|---|---|
| subject_id | int(7) | No | |
| service_id | int(2) | No | 0 |
| subject_name | varchar(32) | No | |
| subject_uuid | varchar(6) | No | |

| | | | |
|---|---|---|---|
| Field | Type | Null | Default |

Table Structure for Table Subscribers

| | | | |
|---|---|---|---|
| subscriber_id | int(4) | No | |
| email | varchar(255) | No | |
| stamp | timestamp | Yes | CURRENT_TIMESTAMP |

Table Structure for Table Views

| | | | |
|---|---|---|---|
| subject_id | varchar(6) | No | |
| views | int(11) | No | 0 |

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

What is claimed is:

1. A system for profiling users of a service, comprising:
a database including a plurality of records, each of which describes an experience of said users within the service;
means for rating each of said plurality of records which relates to said experience; and
means for remotely accessing said database.

2. The system according to claim 1, wherein the service comprises an online service.

3. The system according to claim 1, wherein the service comprises a dating service.

4. The system according to claim 1, wherein said plurality of records further comprises a plurality of user profiles.

5. The system according to claim 4, wherein said plurality of records further comprises a report associated with each of said plurality of user profiles.

6. The system according to claim 1, further comprising means for generating a report for association with each said experience.

7. The system according to claim 1, wherein said rating means comprises a scale of from 1 to 10, such that a 1 corresponds to a worst possible experience and a 10 corresponds to a best possible experience.

8. The system according to claim 1, wherein said rating means comprises a scale of from −5 to +5, such that a −5 corresponds to a worst possible experience and a +5 corresponds to a best possible experience.

9. A method of profiling users of a service, comprising:
creating a database including a plurality of records, each of which describes an experience of said users within the service;
rating each of said plurality of records which relates to said experience;
providing means for remotely accessing said database; and
providing means for searching said database.

10. The method according to claim 9, further comprising providing a plurality of user profiles within said plurality of records.

11. The method according to claim 10, further comprising providing a report associated with each of said plurality of user profiles within said plurality of records.

12. The method according to claim 11, further comprising generating a report for association with each said experience.

13. The method according to claim 9, further comprising creating a scale of from 1 to 10 to rate said experience, such that a 1 corresponds to a worst possible experience and a 10 corresponds to a best possible experience.

14. The method according to claim 9, further comprising creating a scale of from −5 to +5 to rate said experience, such that a −5 corresponds to a worst possible experience and a +5 corresponds to a best possible experience.
